(19) United States
(12) Patent Application Publication
(10) Pub. No.: US 2012/0131987 A1
(43) Pub. Date: May 31, 2012

(54) Method and Apparatus for Gas Chromatographic Analysis of a Gas Mixture

(75) Inventors: Udo Gellert, Bellheim (DE); Frank Probst, Herxheim bei Landau/Pfalz (DE)

(73) Assignee: Siemens Aktiengesellschaft, Munchen (DE)

(21) Appl. No.: 13/133,856

(22) PCT Filed: Dec. 9, 2009
(86) PCT No.: PCT/EP09/66666

§ 371 Date: Aug. 8, 2011

(30) Foreign Application Priority Data
Dec. 9, 2008 (DE) 10 2008 061 158.1

(51) Int. Cl. G01N 30/04

(52) U.S. Cl. 73/23.42

(57) ABSTRACT

A method for analyzing a gas mixture through gas chromatography, wherein a sample of the gas mixture is fed to a dosing volume using a metering valve in a first valve position and, in a second valve position the sample of the gas mixture is fed from the dosing volume through a separating device by a carrier gas. A gas component of interest, arriving at the separating device and separated from the sample, is detected by a detecting device. Part of the separating device and the metering valve are flushed with another carrier gas after the gas component of interest has passed through a part of the separating device to facilitate a precise gas chromatography analysis using minimal technical effort. Another gas sample is then fed from the dosing volume to the separating device using the other carrier gas.

### BACKGROUND OF THE INVENTION

1. Field of the Invention

The invention relates to a method for the gas chromatographic analysis of a gas mixture, a sample of which is sent to a dosing volume by a dosing valve located in a first valve position and, in a second valve position, the sample is sent by a carrier gas from the dosing volume through a separating device, at the end of which at least one gas component of interest arriving there and separated from the sample is detected by a detector and is quantitatively determined based on a detector signal supplied by the detector.

The invention also relates to an apparatus for performing the method.

2. Description of the Related Art

Certain gas components, such as hydrogen, cannot be clearly determined with commonly used carrier gases, such as helium. If a different carrier gas is used instead, although the use of the different carrier gas allows such gas components to be clearly re-determined, other gas components of the gas mixture to be analyzed are then often no longer determinable, or only with reduced accuracy or sensitivity.

It is known from JP 6-258306 A to increase the measuring sensitivity in the gas chromatographic analysis of a gas mixture containing hydrogen and hydrocarbons by changing the carrier gas that is used during the analysis. Initially, the sample is sent by the use of nitrogen as a first carrier gas through a separating device comprising two separating portions, at the end of which the hydrogen is detected and quantitatively determined. Next, once the first carrier gas and the sample have reached the second separating portion, the hydrocarbons are sent through the second separating portion to the detector by helium functioning as a second carrier gas, while the first separating portion is backflushed with the nitrogen. The changeover of the carrier gas in the middle of the separating device can be problematic, because the hydrocarbons are initially still contained in the nitrogen and are only taken up by the helium in the further path of the second separating portion.

CN 1885031 A discloses a method for gas chromatographic analysis of a gas mixture containing oxygen, nitrogen and hydrogen in which nitrogen or argon is used as a first carrier gas to determine the hydrogen, and hydrogen is used as a second carrier gas to determine the other gas components. For this purpose, the gas mixture is passed by a dosing valve located in a first valve position through two different dosing volumes, which consequently provide two samples of the gas mixture. Simultaneously, a first separating device is flushed with the first carrier gas and a second separating device is flushed with the second carrier gas. In the second valve position, the first sample is sent by the first carrier gas through the first separating device and the second sample is sent by the second carrier gas through the second separating device. A changeover device is provided at the end of the two separating devices, by way of which either the separated gas components leaving the first separating device or the separated gas components leaving the second separating device are fed to a detector. The separated gas components may be disturbed by the changeover device at the end of the separating devices, which reduces the accuracy of the detection. Furthermore, it must be ensured that the gas components from the different separating devices arrive at the changeover device at a sufficiently great time difference from each other. Finally, the expenditure in terms of apparatus is considerable, because two gas chromatographs are actually used, and although they have a common dosing valve and a common detector, the dosing valve with the two dosing volumes is a more complex construction than that in the case of a single gas chromatograph, and the additional changeover device is required. Therefore, the alternative possibility of analyzing the same gas mixture in two different gas chromatographs with two different carrier gases, and combining the measurement results of the two analyses is worthy of consideration.

### SUMMARY OF THE INVENTION

It is therefore an object of the invention to provide a method for achieving accurate gas chromatographic analysis with minimal technical expenditure.

This and other objects and advantages are achieved in accordance with the invention by providing a method by which, once the at least one gas component of interest has passed through at least part of the separating device, this part of the separating device and the dosing valve are flushed with a further carrier gas, different from the original carrier gas, and then a further sample is sent by the further carrier gas from the dosing volume into the separating device.

Generally, a sample of the gas mixture is initially passed through the separating device with the one (i.e., first or original) carrier gas. At the latest, when the gas component of interest has been detected at the end of the separating device, the separating device is flushed with the second carrier gas and then a further sample of the gas mixture is sent by the further (i.e., second) carrier gas from the dosing volume into the separating device. This further sample, which may, for example, be introduced into the dosing volume during the analysis performed with the first carrier gas, can likewise be detected at the end of the separating device. However, it is also possible to detect gas components of interest of the further sample in advance by the further detector, disposed between the dosing valve and the detector in the path of the separating device, or to discharge the gas components of interest from the separating device and feed them to a further separating device with a downstream further detector by a gas changeover device disposed in the path of the separating device, such as that known from WO 03/083467 A2. Such a gas changeover device also makes it possible to flush the part of the separating device already disposed between the dosing valve and the gas changeover device with the second carrier gas, already once the gas component of interest transported by the first carrier gas has passed the gas changeover device. In order for the gas component of interest to be further transported therein, the first carrier gas is then introduced at the gas changeover device into the rear part of the separating device.

In the case of a gas mixture containing hydrogen and hydrocarbons, argon or nitrogen is preferably used as the carrier gas for separating and detecting the hydrogen, and helium is preferably used as the carrier gas for separating and detecting the hydrocarbons.

To realize the carrier gas changeover, a first and a second carrier gas source as well as a controllable valve switching device are provided, connecting either the first or the second carrier gas source to the gas chromatograph, depending on the switching position. The valve switching device preferably includes three controllable three-way valves, of which a first valve and a second valve are disposed between the first carrier gas source and the gas chromatograph and a third valve and the second valve disposed between the second carrier gas source and the gas chromatograph. This ensures that the carrier gas not being used in each case is always shut off by two valves, and the two carrier gases are always separated by two valves and the gas path disposed between them. Preferably, the first and third valves are formed as three-way valves, venting the gas path between them and the second three-way valve by an outlet for each in the valve position shutting off the respective carrier gas. Consequently, the pressure between the two shut-off positions for the two carrier gases is limited to ambient pressure, so that the two carrier gases cannot mix, even in the event of a simple error.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference is made hereafter to the figures of the drawings, in which:

FIG. 1 shows an exemplary schematic block diagram of a gas chromatograph, which is supplied with two different carrier gases, one after the other, by way of a valve switching device in accordance with the invention;

FIG. 2 shows an exemplary schematic block diagram of a gas chromatograph supplied with two carrier gases in accordance with an alternative embodiment of the invention; and

FIG. 3 is a flow chart of the method in accordance with an embodiment of the invention.

### DETAILED DESCRIPTION OF THE PREFERRED EMBODIMENTS

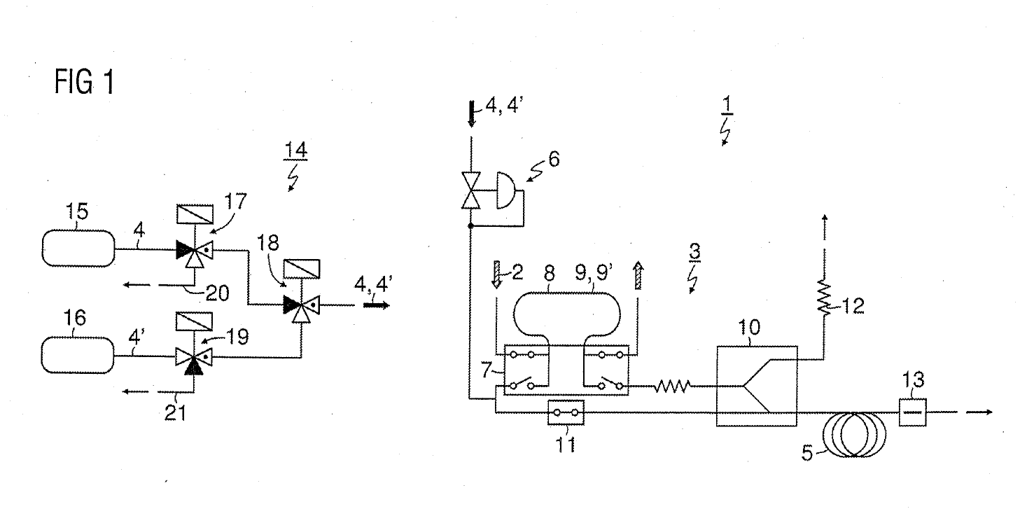

In the case of the gas chromatograph 1 shown in FIG. 1, a gas mixture 2 to be analyzed is fed to a dosing device 3 after being removed from a technical process. The dosing device 3 fires a predetermined dosage of the gas mixture 2 in a short and sharply delimited sample shot into a carrier gas stream 4 at a predetermined point in time and feeds the sample shot to a separating device 5. The pressure, and consequently the flow rate, of the carrier gas stream 4 are controlled by a pressure controller 6. The dosing device 3 has a dosing valve 7 which, in a first switching position (not shown), sends the gas mixture 2 into a dosing volume 8. In a second switching position, the dosing volume 8 is switched into the path for the carrier gas stream 4, which feeds the sample 9 of the gas mixture 2 contained in the dosing volume 8 to an injector 10. As long as a solenoid valve 11 is open, the carrier gas stream 4 flows through the solenoid valve 11 and the injector 10 into the separating device 5, while the sample 9 is led away to the outside from the dosing volume 8 by a flow restrictor 12. If the solenoid valve 11 is closed for a predetermined period of time, part of the sample 9 is branched off in the injector 10 and fired as a sharply delimited sample shot into the carrier gas stream 4 to the separating device 5. The gas components of the gas mixture 2 that are contained in the sample shot are separated as they flow through the separating device 5 and appear one after the other at the end of the separating device 5, where they are detected by a detector 13 and quantitatively determined by evaluation of a detector signal supplied by the detector 13. In the simplest case shown here, the separating device 5 consists of a separating column.

The pressure controller 6 of the gas chromatograph 1 is connected on the input side by a controllable valve switching device 14 to two carrier gas sources 15 and 16, one of which provides the carrier gas 4 and the other provides a further carrier gas 4′ that is different from the first carrier gas. Depending on the switching position of the valve arrangement 14, either the one carrier gas 4 or the further carrier gas 4′ is introduced into the gas chromatograph 1. For this purpose, the valve arrangement 14 has a first three-way valve 17 and a second three-way valve 18, which are disposed one behind the other between the first carrier gas source 15 and the gas chromatograph 1, and a third three-way. valve 19 between the second carrier gas source 16 and the second three-way valve 18. The first three-way valve 17 and the third three-way valve 19 each have an outlet 20 and 21, respectively, by which the gas path between them and the second three-way valve 18 is vented when they are in the valve position shutting off the respective carrier gas 4 or 4′. In the valve position shown, the first carrier gas 4 flows out of the first carrier gas source 15 through the valves 17 and 18 into the gas chromatograph 1, while the valve 19 shuts off the second carrier gas 4′ and vents the gas path between the valves 18 and 19 through the outlet 21. In the other valve position (not shown), the second carrier gas 4′ flows out of the second carrier gas source 16 through the valves 19 and 18 into the gas chromatograph 1, while the valve 17 shuts off the first carrier gas 4 and vents the gas path between the valves 18 and 17 through the outlet 20. The carrier gases 4 and 4′ are therefore always separated by two valves and the gas path disposed between them, which limits pressure between the two shut-off points to ambient pressure. This ensures that the two carrier gases 4 and 4′ cannot mix, even in the event of a simple error. To prevent air from being able to penetrate into the gas path between the two shut-off points, the outlets 20, 21 comprise sufficiently long gas lines with a correspondingly long diffusion path for the air.

In a first step, the gas paths of the chromatograph 1 are flushed or filled with the carrier gas stream 4. The dosing volume 8 is then filled with a first sample 9 of the gas mixture 2 and the first sample 9 is injected into the carrier gas stream 4. Of the components of the first sample 9 that are separated as they flow through the separating device 5, all or some selected sample components are detected and quantitatively determined at the end of the separating device 5. Next, the gas paths of the chromatograph 1 are flushed or filled with the second carrier gas stream 4. Subsequently, the dosing volume 8 is filled with a second sample 9′ of the gas mixture 2 and the second sample 9′ is injected into the carrier gas stream 4′. Of the components of the second sample 9′ that are separated as they flow through the separating device 5, all or some selected sample components are detected and quantitatively determined at the end of the separating device 5.

If, in the depicted switching position of the valve arrangement 14, only the valve 18 is switched over, the carrier gas pressure from the gas chromatograph 1 is reduced backwardly by the outlet 21 of the valve 19. If this operation is repeated a number of times one after the other, even points in the gas path that are indirectly flushed with the currently activated carrier gas stream 4 can be purged of the previously activated carrier gas stream 4′. In this way, the flushing time required after each carrier gas changeover can be shortened.

If the gas mixture 2 comprises hydrogen and hydrocarbons, argon or nitrogen are used, for example, as the first carrier gas stream 4 (or second carrier gas stream 4′) for separating and detecting the hydrogen and helium is used as the second carrier gas stream 4′ (or first carrier gas stream 4) for separating and detecting the hydrocarbons.

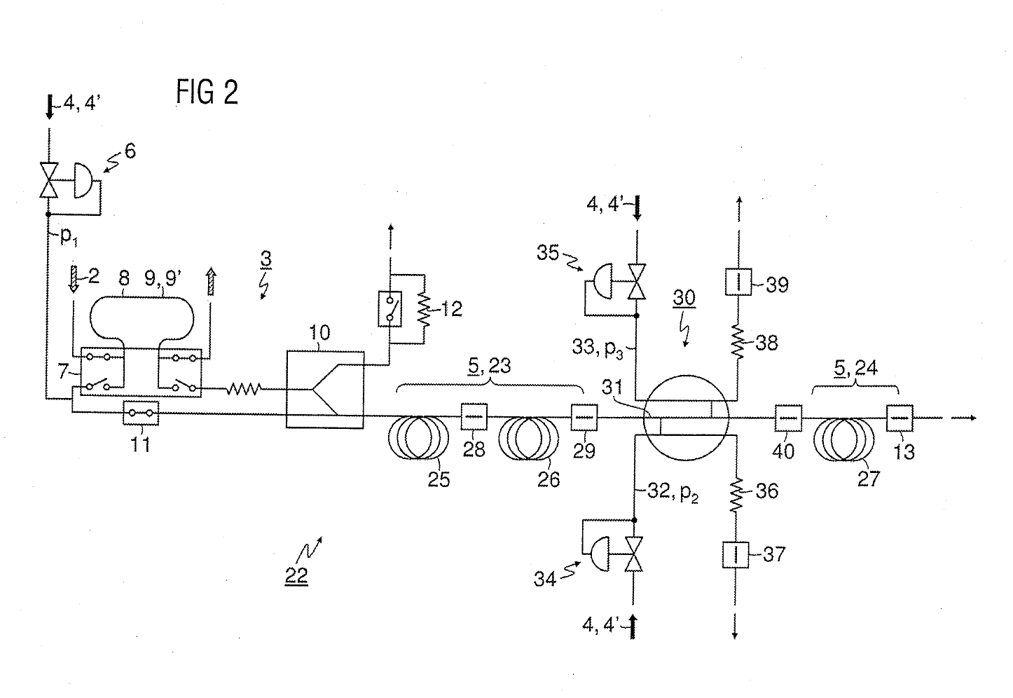

In the case of the example of a gas chromatograph 22 that is shown in FIG. 2, the separating device 1 consists of two successive separating arrangements 23 and 24 comprising separating columns 25, 26 and 27 arranged one behind the other, each of which have different separating properties and can be subjected to a different temperature control. At the end of each separating column 25, 26, 27, a detector 28, 29 or 13 is respectively arranged for detecting components of the gas mixture 2 that have been predetermined and by this time completely separated. Inserted between the first separating arrangement 23 and the second separating arrangement 24 is a gas changeover device 30 having a main gas path 31 connecting the two separating arrangements 23 and 24 to each other, and two auxiliary gas paths 32 and 33, of which the auxiliary gas path 32 is connected to the main gas path 31 at a point lying closer to the separating arrangement 23 and the auxiliary gas path 33 is connected to the main gas path 31 at a point lying closer to the separating arrangement 24. Both auxiliary gas paths 32 and 33 are respectively subjected to a flow of one of the carrier gas streams 4, 4′ on the inlet side by a pressure controller 34 or 35 and respectively have on the outlet side a flow resistance 36 or 37 and a detector 38 or 39. If the carrier gas pressure p₁, provided by the pressure controller 6 is set greater than the carrier gas pressure p₂ in the auxiliary gas path 32 and the pressure p₂ is in turn set greater than the carrier gas pressure p₃ in the auxiliary gas path 33, the first-selected first carrier gas 4 is sent with the sample 9 through the separating columns 25, 26 and 27 one after the other, where it is possible for separate sample components to be detected downstream of each separating column 25, 26, 27. As soon as the undetected last sample component has passed the gas changeover device 30, which can be detected by an additional detector 40 at the output of the main gas path 31, the dosing device 3 and the first separating arrangement 23 can already be flushed with the second carrier gas stream 4′, while the sample 9 is sent by the first carrier stream gas 4 through the second separating arrangement 24. For this purpose, the carrier gas pressure p₃ in the auxiliary gas path 33 is set greater than the carrier gas pressure p₂ in the auxiliary gas path 32, so that a greater part of the carrier gas stream 4 from the auxiliary gas path 33 arrives in the main gas path 31 and in turn branches there into a partial stream sending the sample 9 through the second separating arrangement 24 and a partial stream flowing backwardly into the auxiliary gas path 32. The first separating arrangement 23 is then fluidically decoupled from the second separating arrangement 24 and can be flushed with the second carrier gas stream 4′ by the pressure controller 6. When the sample 9 in the first carrier gas stream has been detected at the end of the second separating arrangement 24, the second separating arrangement 24 can also be flushed with the second carrier gas stream 4′. Subsequently, the second sample 9′ can then be injected into the second carrier gas stream 4′, separated and detected in the further path of the separating device 5.

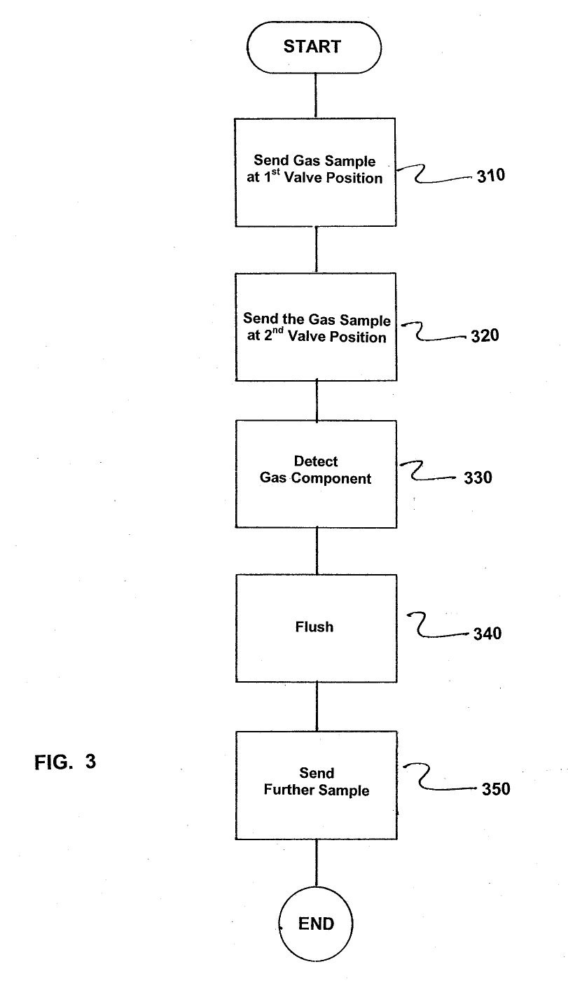

FIG. 3 is a flow chart of a method for the gas chromatographic analysis of a gas mixture. The method comprises sending a sample of the gas mixture to a dosing volume through a dosing valve located in a first valve position, as indicated in step 310. In a second valve position, the sample of the gas mixture is sent by a carrier gas from the dosing volume through a separating device, as indicated in step 320.

At least one gas component of interest arriving at the separating device and separated from the sample by the separating device is detected by a detector arranged at an end of the separating device and the at least one gas component of interest based on a detector signal supplied is quantitatively determined by the detector, as indicated in step 330.

At least part of the separating device and the dosing valve are flushed with a further carrier gas, different from the carrier gas, after the at least one gas component of interest has passed through the at least part of the separating device, as indicated in step 340. A further sample is sent by the further carrier gas from the dosing volume into the separating device, as indicated in step 350.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1-9. (canceled)

10. A method for the gas chromatographic analysis of a gas mixture, comprising:
sending a sample of the gas mixture to a dosing volume through a dosing valve when the dosing valve is in a first valve position;
sending the sample of the gas mixture carried by a first carrier gas from the dosing volume through a separating device when the dosing valve is in a second valve position;
detecting, by a detector arranged at an end of the separating device, at least one gas component of interest arriving at the separating device and separated from the sample by the separating device and quantitatively determining the at least one gas component of interest based on a detector signal supplied by the detector;
flushing at least part of the separating device and the dosing valve with a further carrier gas, different from the first carrier gas, after the at least one gas component of interest has passed through the at least part of the separating device; and
sending a further sample of the gas mixture by the further carrier gas from the dosing volume into the separating device.

11. The method as claimed in claim 10, further comprising:
detecting and separating at least one further gas component of interest arriving at a detector arranged at the end of the separating device from the further sample and quantitatively determining the at least one further gas component of interest based on the detector signal supplied by the detector.

12. The method as claimed in claim 10, further comprising:
detecting at least one further gas component from the further sample by a further detector disposed between the dosing valve and the detector arranged at the end of the separating device.

13. The method as claimed in claim 11, further comprising:
detecting the at least one further gas component by a further detector disposed between the dosing valve and the detector arranged at the end of the separating device.

14. The method as claimed in claim 11, further comprising:
discharging the at least one further gas component, by a gas changeover device disposed between the dosing valve and the detector arranged at the end of the separating device, from the separating device and supplying the at least one further gas component to a further separating device with a downstream further detector.

15. The method as claimed in claim 10, further comprising:
flushing at least part of the separating device disposed upstream of a gas changeover device with a further carrier gas after the at least one gas component of interest has passed the gas changeover device disposed between the dosing valve and the detector disposed at the end of the separating device; and
feeding the carrier gas, by the gas changeover device disposed between the dosing valve and the detector disposed at the end of the separating device, into at least part of the separating device disposed downstream of the gas changeover device to pass on the at least one gas component of interest.

16. The method as claimed in claim 10, wherein one of argon and nitrogen is used as the first carrier gas for separating and detecting hydrogen when the gas mixture contains one of the hydrogen and hydrocarbons, and helium is used as the further carrier gas for separating and detecting hydrocarbons when the gas mixture contains one of the hydrogen and hydrocarbons.

17. An apparatus for gas chromatographic analysis of a gas mixture, comprising:
a first carrier gas source;
a second carrier gas source;
a gas chromatograph; and
a controllable valve switching device which connects one of the first carrier gas source and the second carrier gas source to the gas chromatograph depending on a switching position.

18. The apparatus as claimed in claim 17, wherein the controllable valve switching device includes a plurality of controllable three-way valves, a first valve and a second valve of the plurality of controllable three-way valves being disposed between the first carrier gas source and the gas chromatograph, and a third valve and the second valve of the plurality of controllable three-way valves being disposed between the second carrier gas source and the gas chromatograph.

19. The apparatus as claimed in claim 18, wherein the first valve and the third valve of the plurality of controllable three-way valves comprises three-way valves and, in a valve position shutting off a respective carrier gas, vent a gas path between them and the second three-way valve by a respective outlet for the first valve and the third valve.

20. The apparatus as claimed in claim 17, wherein the gas chromatograph comprises a dosing valve switchable between two positions, a separating device and a detector, the dosing valve directing a sample of the gas mixture to a dosing valve when the dosing valve is in a first position and sending the sample of the gas mixture, carried by a first carrier gas from the first carrier gas source, from the dosing volume into the separating device.

21. The apparatus as claimed in claim 20, wherein the gas chromatograph is configured such that once a gas component of interest in the sample of the gas mixture has passed through at least part of the separating device, the at least part of the separating device and the dosing valve are flushed with a further carrier gas from the second carrier gas source.
